(19) United States
(12) Patent Application Publication
(10) Pub. No.: US 2009/0192042 A1
(43) Pub. Date: Jul. 30, 2009

(54) SUPERCONDUCTING CABLE PROVIDED WITH ENHANCED COOLING ABILITY

(75) Inventors: Do Hyoung Kim, Gyeonggi-do (KR); Wan Ki Park, Gyeonggi-do (KR); Choon Dong Kim, Gyeonggi-do (KR); Hyun Man Jang, Gyeonggi-do (KR); Bong Ki Ji, Gyeonggi-do (KR); Mi Kyoung An, Daegu (KR); Nam Yul Kim, Gyeongsangbuk-do (KR)

Correspondence Address: MCDERMOTT WILL & EMERY LLP, 600 13TH STREET, N.W., WASHINGTON, DC, 20005-3096, US

(73) Assignee: LS CABLE LTD.

(21) Appl. No.: 12/358,597

(22) Filed: Jan. 23, 2009

(30) Foreign Application Priority Data
Jan. 25, 2008 (KR) 10-2008-0007895

(51) Int. Cl. H01B 12/16; H01B 12/04; H01B 12/00; H01B 3/00

(52) U.S. Cl. 505/230; 174/125.1; 174/8

(57) ABSTRACT

Provided is a superconducting cable provided with an enhanced cooling ability, the superconducting cable including a core including a superconducting wire rod; an inner sheath surrounding the core; an outer sheath surrounding the inner sheath; a plurality of communication pipes that have both ends communicating with the inner and outer sheaths, and are mounted in the longitudinal direction of the inner and outer sheaths; a plurality of valves that are mounted in the communication pipes; and a plurality of auxiliary cooling systems that are mounted on some of the communication pipes. Cooling fluid supplied from the cooling systems is supplied into the inner sheath through the communication pipes, and is then discharged to the outside through the valves.

### PRIORITY STATEMENT

This application claims priority under 35 U.S.C. §119 the benefit of Korean Patent Application No. 10-2008-0007895, filed on Jan. 25, 2008, in the Korean Intellectual Property Office (KIPO), the entire contents of which are incorporated herein by reference.

### BACKGROUND

1. Technical Field

The present invention relates to a superconducting cable. More particularly, the present invention relates to a superconducting cable of which the initial cool-down time can be reduced and the superconductivity can be enhanced, and which can quickly return to the normal temperature.

2. Description of the Related Art

FIG. 1 is a conceptual view of a conventional superconducting cable. FIG. 2 is a horizontal cross-sectional view of the superconducting cable shown in FIG. 1.

As shown in FIG. 1, the superconducting cable 10 has terminal portions 17a and 17b mounted on both ends thereof. At one terminal portion 17a, a cooling system 19 is mounted to supply cooling fluid 23 into the superconducting cable 10. At the other terminal portion 17b, a discharge unit 21 is installed to discharge the cooling fluid 23. Further, as shown in FIG. 2, the superconducting cable 10 includes a core 11 positioned in the center thereof, the core 11 including a superconducting wire rod. The core 11 is surrounded by an inner sheath 13, and the inner sheath 13 is surrounded by an outer sheath 15. The cooling fluid 23 flows through a space between the core 11 and the inner sheath 13, and a space between the inner sheath 13 and the outer sheath 15 is maintained as a vacuum state so as to be thermally insulated.

The superconducting cable 10 constructed in such a manner is a power transmission cable using the property of a superconducting wire rod of which the resistance rapidly decreases at low temperature (for high-temperature superconductivity, less than about 100K; for low-temperature superconductivity, less than about 20K) so as to approximate to 0. The superconducting cable is being recognized as a next generation cable.

Among superconducting cables, a high-temperature superconducting cable has superconductivity that can be maintained by liquid nitrogen which is easily available and inexpensive. Therefore, studies for developing the high-temperature superconducting cable are actively conducted. The superconducting cable described in this specification is a high-temperature superconducting cable.

When a current is applied, the temperature of the superconducting cable is maintained at about 70-77K. When the superconducting cable is cooled down from the initial normal-temperature state, it may take a very long time, depending on the length of the cable. When a superconducting cable has a large length, a reduction in the cool-down time is an important factor for developing the superconducting cable.

Meanwhile, while the cooling fluid (liquid or gas), which is cooled down by the cooling system 19 so as to be introduced into the superconducting cable, flows along the superconducting cable, the temperature of the cooling fluid increases. As the temperature of the cooling fluid increases, the volume thereof increases, so that the cooling fluid cannot escape easily. As a result, the flow rate of the cooling fluid decreases.

When the flow rate of the cooling fluid decreases, the superconducting cable is not cooled down sufficiently. As a result, the superconductivity of the superconducting cable is degraded.

Further, because even when the temperature of the superconducting cable increases up to the normal temperature, the cooling fluid is discharged through the discharge unit installed at the terminal portion of the cable, it takes a long time until the superconducting cable returns to the normal temperature.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to solve the above-described problems associated with the prior art.

The present invention provides a superconducting cable in which cooling fluid is supplied from the longitudinal middle portions of the superconducting cable, and when the volume of the cooling fluid expands due to heating, the cooling fluid is discharged to the outside. Therefore, the cooling rate of the superconducting cable is improved, and the low-temperature state of the superconducting cable is maintained uniformly along the overall length such that the superconductivity of the superconducting cable can be maximized.

According to an aspect of the present invention, a superconducting cable provided with an enhanced cooling ability comprises a core including a superconducting wire rod; an inner sheath surrounding the core; an outer sheath surrounding the inner sheath; a plurality of communication pipes that have both ends communicating with the inner and outer sheaths, and are mounted in the longitudinal direction of the inner and outer sheaths; a plurality of valves that are mounted in the communication pipes; and a plurality of auxiliary cooling systems that are mounted on some of the communication pipes. Cooling fluid supplied from the cooling systems is supplied into the inner sheath through the communication pipes, and is then discharged to the outside through the valves.

According to an embodiment of the present invention, the inner sheath may be divided into a plurality of inner-sheath units along the longitudinal direction thereof, the outer sheath may be divided into a plurality of outer-sheath units having the same length as the inner-sheath units, communication members obtained by cutting the communication pipe in the longitudinal direction thereof may be fixed to both ends of the inner- and outer-sheath units, respectively, and when the plurality of inner- and outer-sheath units are connected in the longitudinal direction thereof, the communication members fixed to the ends facing each other may be fixed so as to come in contact with each other, thereby forming the communication pipe.

According to another embodiment of the present invention, the inner sheath may have a plurality of through-holes formed in the longitudinal direction thereof, one ends of the communication pipes may be fixed to the through-holes, the outer sheath may have a plurality of through-holes formed in the longitudinal direction thereof, the through-holes having a larger diameter than the outer diameter of the communication pipe, and a space between the communication pipe and the through-hole of the outer sheath may be closed by a lid plate.

### BRIEF DESCRIPTION OF THE DRAWINGS

The above and other features of the present invention will now be described in detail with reference to certain example embodiments thereof illustrated in the accompanying drawings which are given hereinbelow by way of illustration only, and thus are not limitative of the present invention, and wherein:

FIG. 1 is a conceptual view of a conventional superconducting cable;

FIG. 2 is a horizontal cross-sectional view of the superconducting cable shown in FIG. 1;

FIG. 3 is a conceptual view of a superconducting cable according to an embodiment of the present invention;

FIG. 4A is a horizontal cross-sectional view of a discharge valve of the superconducting cable shown in FIG. 3;

FIG. 4B is a horizontal cross-sectional view of an auxiliary cooling system of the superconducting cable shown in FIG. 3;

FIG. 5 is a schematic view showing a manufacturing process of the superconducting cable shown in FIG. 3; and

FIG. 6 is a schematic view showing another manufacturing process of the superconducting cable shown in FIG. 3.

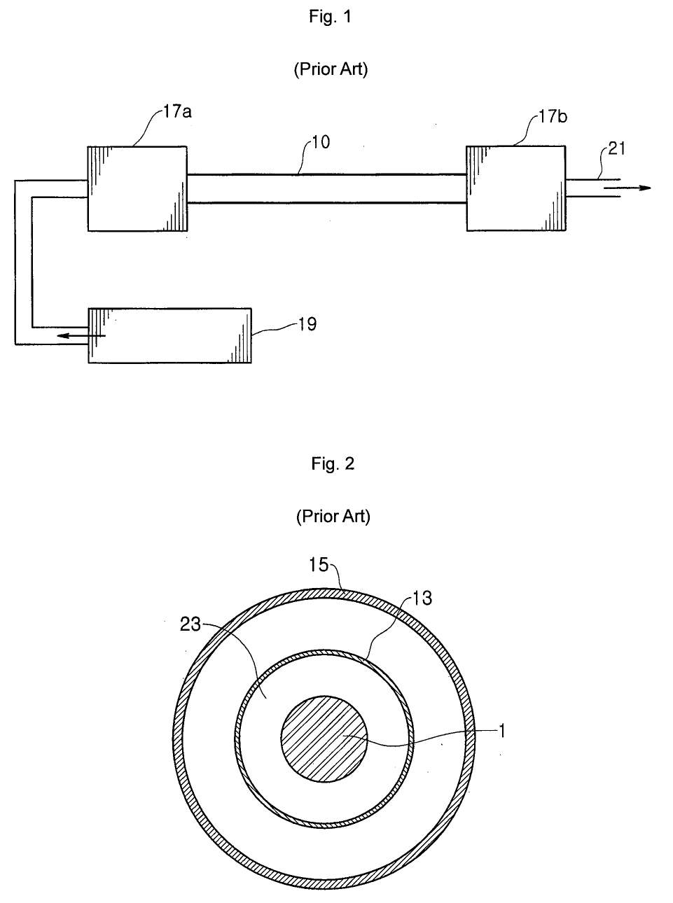

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations and shapes will be determined in part by the particular intended application and use environment.

In the figures, reference numerals refer to the same or equivalent parts of the present invention throughout the figures of the drawing.

### DETAILED DESCRIPTION OF EXAMPLE EMBODIMENTS

Hereinafter, reference will now be made in detail to various embodiments of the present invention, examples of which are illustrated in the accompanying drawings and described below. While the invention will be described in conjunction with example embodiments, it will be understood that the present description is not intended to limit the invention to those example embodiments. On the contrary, the invention is intended to cover not only the example embodiments, but also various alternatives, modifications, equivalents and other embodiments, which may be included within the spirit and scope of the invention as defined in the appended claims.

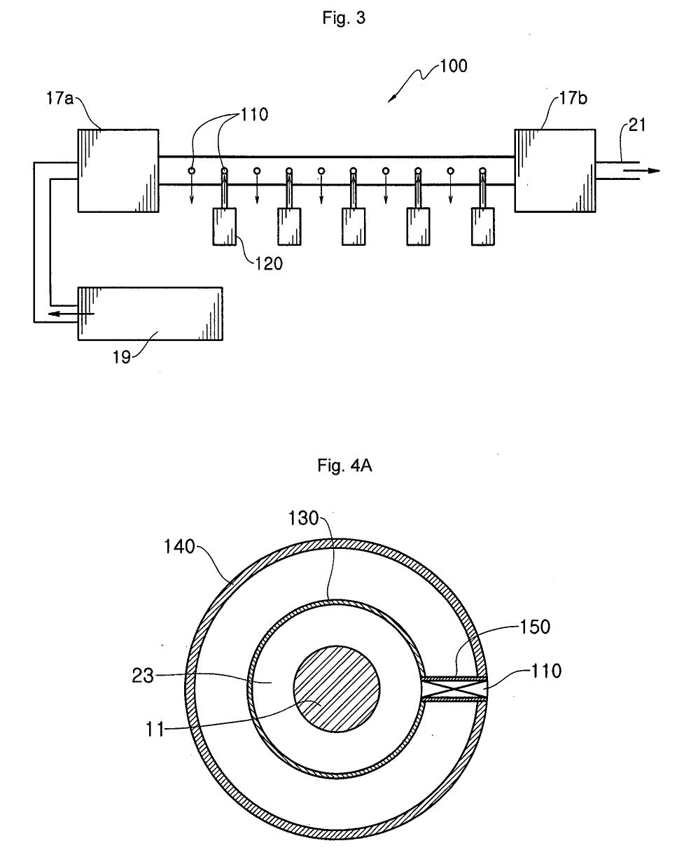

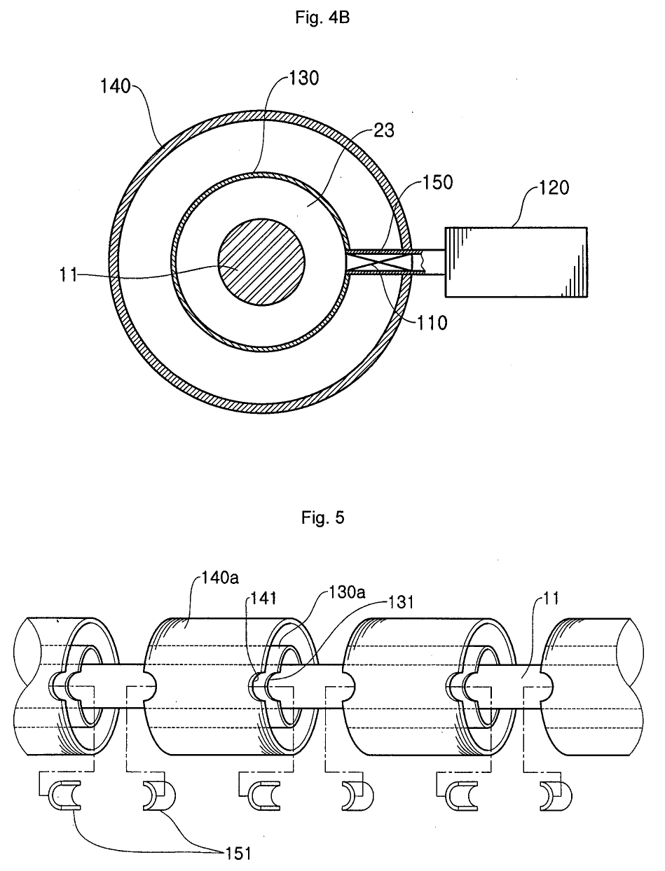

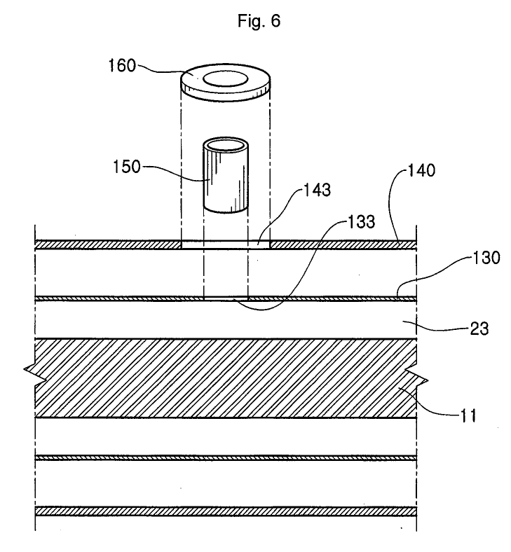

FIG. 3 is a conceptual view of a superconducting cable according to an embodiment of the present invention. FIG. 4A is a horizontal cross-sectional view of a discharge valve of the superconducting cable shown in FIG. 3, and FIG. 4B is a horizontal cross-sectional view of an auxiliary cooling system of the superconducting cable shown in FIG. 3. FIG. 5 is a schematic view showing a manufacturing process of the superconducting cable shown in FIG. 3. FIG. 6 is a schematic view showing another manufacturing process of the superconducting cable shown in FIG. 3.

As shown in FIG. 3, the superconducting cable 100 has terminal portions 17a and 17b mounted at both ends thereof. At one terminal 17a, a cooling system 19 is mounted to supply cooling fluid 23 into the superconducting cable 100. At the other terminal 17b, a discharge unit 21 for discharging the cooling fluid 23 is installed. Further, the superconducting cable 100 has a plurality of valves 110 mounted in the longitudinal direction thereof. Some of the valves 110 have an auxiliary cooling system 120 mounted thereon so as to supply the cooling fluid 23 into the superconducting cable 100, and the cooling fluid 23 is discharged to the atmosphere through the other valves 110.

The valves 110 are mounted as shown in FIGS. 4A and 4B.

The superconducting cable 100 includes a core 11 positioned in the center thereof, the core 11 including a superconducting wire rod. The core 11 is surrounded by an inner sheath 130, and the inner sheath 130 is surrounded by an outer sheath 140. The cooling fluid 23 flows through a space between the core 11 and the inner sheath 130, and a space between the inner sheath 130 and the outer sheath 140 is in vacuum state.

The valve 110 is mounted in a communication pipe 150 which connects the inner sheath 130 and the outer sheath 140. Therefore, the cooling fluid 23 is supplied into the inner sheath 130 through the valve 110 mounted in the communication tube 150, or the cooling fluid 23 heated in the inner sheath 130 is discharged through the valve 110.

In the superconducting cable constructed in such a manner, when n auxiliary cooling systems 120 are mounted at even intervals in the plurality of valves 110 formed in the superconducting cable 100, the cooling time of the superconducting cable 100 is reduced to approximately 1/(n+1), compared with that of the conventional superconducting cable 10 which supplies cooling fluid from one side.

Further, the cooling fluid 23 can be discharged through the valves 110 on which the auxiliary cooling systems 120 are not mounted. Therefore, the superconducting cable 100 can return to the normal temperature more quickly than the conventional superconducting cable 100.

Further, since the n auxiliary cooling systems 120 supply cooling fluid, a flow distance of the cooling fluid 23 is reduced so that the low-temperature state of the superconducting cable 100 can be maintained uniformly along the overall length thereof.

Hereinafter, a process of manufacturing inner and outer sheaths having valves mounted therein will be described.

As shown in FIG. 5, the inner and outer sheaths 130 and 140 are divided into units 130a and 140a with a predetermined unit length, respectively. An inner-sheath unit 130a is positioned inside an outer-sheath unit 140a.

A communication member 151 formed in a semicircular shape is welded and fixed to either end of the inner- and outer-sheath units 130a and 140a. The communication member 151 is formed by cutting the cylindrical communication tube 150 along the longitudinal direction thereof, and is welded and fixed to either end of the inner- and outer-sheath units 130a and 140a.

Meanwhile, semi-circular grooves 131 and 141 are formed at the ends of the inner- and outer-sheath units 130a and 140a such that the communication member 151 can be inserted into the grooves 131 and 141. In a state in which the communication member 151 is positioned in the semi-circular grooves 131 and 141, the outer side surface of the communication member 151 is welded and fixed to the inner surfaces of the semi-circular grooves 131 and 141.

Then, a plurality of inner-sheath units 130a and a plurality of outer-sheath units 140a are welded and fixed to one another in such a state that they are connected through the communication members 151, thereby forming the inner sheath 130 and the outer sheath 140. In this case, when the communication member 151 of one unit comes in contact with the communication member 151 of another unit, they form a cylindrical structure. The communication members which come in contact with each other are welded to form the communication pipe 150.

The valve 110 is mounted in the communication pipe 150 constructed in such a manner.

Meanwhile, according to another process of manufacturing inner and outer sheaths, the inner and outer sheaths 130 and 140 having a length corresponding to the overall length of the superconducting cable 100 respectively include through-holes 133 and 143 formed at a position thereof where a valve 110 is to be installed, as shown in FIG. 6.

The through-hole 133 formed in the inner sheath 130 has the same diameter as the outer diameter of the communication pipe 150, and the through-hole 143 formed in the outer sheath 140 has a larger diameter than the outer diameter of the communication pipe 150. Further, the communication pipe 150 is inserted into the through-hole 143 of the outer sheath 140, and a lower end of the communication pipe 150 is then welded and fixed to the through-hole 133 of the inner sheath 130.

Further, a space between the outer sheath 140 and the communication pipe 150 is closed by a lid plate 160, and the lid plate 160 is welded and fixed to the outer sheath 140 and the communication pipe 150. The lid plate 160 has a disk-shaped structure having a hole formed in the center thereof. The inner diameter of the lid plate 160 is equal to the outer diameter of the communication pipe 150, and the outer diameter of the lid plate 160 is equal to the diameter of the through-hole 143 of the outer sheath 140.

A valve 110 is mounted in the communication pipe 150 fixed to the inner and outer sheaths 130 and 140 and the lid plate 160.

Meanwhile, auxiliary cooling systems 120 are installed in some of a plurality of valves 110 formed in the longitudinal direction of the superconducting cable 100. Every other valve 110 may have an auxiliary cooling system 120 installed therein. Further, inside the inner sheath 130, a core 11 is positioned.

Meanwhile, the superconducting cable 100 manufactured in such a manner is transferred in a state in which it is wound around a drum. If necessary, however, the superconducting cable 100 may be manufactured and installed on the spot.

Further, an extension pipe may be connected to each of the valves 110 on which the auxiliary cooling system 120 is not mounted. In this case, cooling fluid 23 can be discharged through the valve 110 to a place away from the superconducting cable 100, which makes it possible to protect an operator who manages the superconducting cable 100.

The inner diameter of the communication pipe 150 may be set to larger than about 5 mm, and the cross-sectional area of the communication 150 may be set to larger than 20 mm². The communication pipe 150 may be formed in various shapes including circle.

According to the present invention, since the cooling fluid is supplied from the longitudinal middle portions of the superconducting cable, it is possible to reduce the time required for cooling down the superconducting cable to a target temperature.

Further, as heated and expanded cooling fluid is discharged through middle portions of the superconducting cable, the target temperature of the superconducting cable can be maintained uniformly along the overall length thereof. Therefore, it is possible to maximize the superconductivity of the superconducting cable.

Further, it is possible to reduce the time required for returning the temperature of the superconducting cable to the normal temperature, because the cooling fluid is discharged from the middle portions of the superconducting cable.

The invention has been described in detail with reference to preferred embodiments thereof. However, it will be appreciated by those skilled in the art that changes may be made in these embodiments without departing from the principles and spirit of the invention, the scope of which is defined in the accompanying claims and their equivalents.

What is claimed is:

1. A superconducting cable provided with an enhanced cooling ability, comprising:
a core including a superconducting wire rod;
an inner sheath surrounding the core;
an outer sheath surrounding the inner sheath;
a plurality of communication pipes that have both ends communicating with the inner and outer sheaths, and are mounted in the longitudinal direction of the inner and outer sheaths;
a plurality of valves that are mounted in the communication pipes; and
a plurality of auxiliary cooling systems that are mounted on some of the communication pipes,
wherein cooling fluid supplied from the cooling systems is supplied into the inner sheath through the communication pipes, and is then discharged to the outside through the valves.

2. The superconducting cable according to claim 1, wherein the inner sheath is divided into a plurality of inner-sheath units along the longitudinal direction thereof, the outer sheath is divided into a plurality of outer-sheath units having the same length as the inner-sheath units, communication members obtained by cutting the communication pipe in the longitudinal direction thereof are fixed to both ends of the inner- and outer-sheath units, respectively, and when the plurality of inner- and outer-sheath units are connected in the longitudinal direction thereof, the communication members fixed to the ends facing each other are fixed so as to come in contact with each other, thereby forming the communication pipe.

3. The superconducting cable according to claim 1, wherein the inner sheath has a plurality of through-holes formed in the longitudinal direction thereof,
one ends of the communication pipes are fixed to the through-holes,
the outer sheath has a plurality of through-holes formed in the longitudinal direction thereof, the through-holes having a larger diameter than the outer diameter of the communication pipe, and
a space between the communication pipe and the through-hole of the outer sheath is closed by a lid plate.
